(19) United States
(12) Patent Application Publication
(10) Pub. No.: US 2009/0061858 A1
(43) Pub. Date: Mar. 5, 2009

(54) System and Method to Manage Communication Handoff

(75) Inventors: Vijayasimman Rajasimman, Richardson, TX (US); Nivedan Thadasina, Allen, TX (US); John C. Jubin, Richardson, TX (US)

Correspondence Address: DOCKET CLERK, P.O. DRAWER 800889, DALLAS, TX, 75380, US

(73) Assignee: SAMSUNG ELECTRONICS CO., LTD., Gyeonggi-do (KR)

(21) Appl. No.: 11/848,729

(22) Filed: Aug. 31, 2007

(51) Int. Cl. H04Q 7/22

(52) U.S. Cl. 455/433; 455/436

(57) ABSTRACT

A method for reducing a failure of a handoff to a home base station (HBS) is provided. The method includes a user device promoting initiating a handoff request. Responsive to receiving the handoff request from the user device, a mobile switching center (MSC) requests a hub HBS for the user device to sense whether the user device is in range to communicate with the hub HBS. The MSC completes the handoff when the hub HBS senses that the user device is in range and prevents the handoff when the hub HBS does not sense that the user device is in range.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Natural and man-made obstacles can create areas of inadequate coverage in a wireless telecommunications network. For example, a user device may experience a dropped call or an inability to initiate a call when the user device is inside a building or is otherwise blocked from successfully sending or receiving radio frequency (RF) signals. As used herein, the term “user device” refers to devices that might be used by users in a telecommunications network. This typically includes mobile terminals such as mobile telephones, personal digital assistants, handheld computers, and similar devices, but can also include fixed terminals such as residential gateways.

### SUMMARY

In one embodiment, a method for reducing a failure of a handoff to a home base station (HBS) is provided. The method includes a user device promoting initiating a handoff request. Responsive to receiving the handoff request from the user device, a mobile switching center (MSC) requests a hub HBS for the user device to sense whether the user device is in range to communicate with the hub HBS. The MSC completes the handoff when the hub HBS senses that the user device is in range and prevents the handoff when the hub HBS does not sense that the user device is in range.

In another embodiment, a system for reducing a failure of a handoff to an HBS is provided. The system includes an MSC and a sensing component. The MSC is operable to identify a hub HBS for a user device as an intended recipient of a call handoff when the MSC receives a handoff request related to a pseudorandom noise sequence (PN) that is used by a plurality of HBSs controlled by the MSG. The sensing component is on the hub HBS and can determine whether the user device is near enough to the hub HBS to communicate with the hub HBS. When the user device is near enough to the hub HBS to communicate with the hub HBS, the sensing component can promote the hub HBS receiving the call handoff. When the user device is not near enough to the hub HBS to communicate with the hub HBS, the sensing component can cause the MSC to prevent the call handoff.

In another embodiment, an HBS is provided. The HBS includes a sensing component operable to determine whether a user device registered with the HBS is near enough to the HBS to sufficiently communicate with the HBS. When the user device is near enough to the HBS to sufficiently communicate with the HBS, the sensing component can allow the HBS to receive a handoff of a call. When the user device is not near enough to the HBS to sufficiently communicate with the HBS, the sensing component can cause an MSC to prevent the handoff.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a diagram of a telecommunications system according to an embodiment of the disclosure.

FIG. 2 is a diagram of another telecommunications system according to an embodiment of the disclosure.

FIG. 3 is a diagram of a method for preventing the failure of a handoff to a home base station according to an embodiment of the disclosure.

FIG. 4 is a diagram of a wireless communications system including a user device operable for some of the various embodiments of the disclosure.

FIG. 5 is a block diagram of a user device operable for some of the various embodiments of the disclosure.

FIG. 6 is a diagram of a software environment that may be implemented on a user device operable for some of the various embodiments of the disclosure.

FIG. 7 is an illustrative general purpose computer system suitable for some of the various embodiments of the disclosure.

### DETAILED DESCRIPTION

It should be understood at the outset that although illustrative implementations of one or more embodiments are illustrated below, the disclosed systems and/or methods may be implemented using any number of techniques, whether currently known or in existence. The disclosure should in no way be limited to the illustrative implementations, drawings, and techniques illustrated below, but may be modified within the scope of the appended claims along with their full scope of equivalents.

Various types of private base station have been proposed to deal with areas of inadequate coverage in a telecommunications network. These units can perform functions similar to those performed by a publicly accessible base station but at a reduced power. The term “home base station” (HBS) will be used herein to refer to such base stations, but it should be understood that the units could be used in business offices, government buildings, schools, and other locations besides homes.

While a traditional wireless telecommunications base station might provide coverage over a wide geographic region for a large number of users, an HBS might provide coverage only in an area the size of a typical home and for only a limited number of users. When an HBS is placed inside a home, for example, a user device in the home can send RF signals to and receive RF signals from the HBS rather than making potentially unsuccessful attempts at sending RF signals to and receiving RF signals from a traditional, publicly accessible base station. The HBS can then communicate with subsequent components in a telecommunications network. Connecting to the telecommunications network via the HBS can shrink or eliminate areas of inadequate coverage that might exist in the home when connections are attempted via a traditional base station.

An HBS is typically intended for use by only a small number of user devices. An identifier for each user device authorized to use a particular HBS might be associated with an identifier for that HBS. Only the user devices that have been registered with the HBS in this manner might be able to gain access to the HBS. For example, an HBS in a home might be configured to be used only by user devices belonging to family members who live in that home. A different user device that entered or came near the home might not be able to gain access to the HBS. Similarly, the family members from that home might not be able to use an HBS in a different home. The HBS with which a user device has been associated will be referred to herein as the hub HBS for that user device.

As is well known in the art, a code division multiple access (CDMA) base station might broadcast a beacon signal that provides information about the base station. User devices can use the beacon signal to determine which base station to connect to and to determine whether a call should be handed off from one base station to another. For a traditional, publicly accessible base station, the beacon signal typically operates at approximately the same power as the signal that carries the actual voice and data traffic. For an HBS, the beacon signal typically operates at a greatly reduced power so that the beacon signal can be detected only by user devices that are physically close to the HBS, such as user devices that are in the same home as the HBS.

A traditional, publicly accessible base station might transmit voice and data traffic to subsequent components in the telecommunications network via RF signals. For some HBSs, voice and data traffic might be transmitted to the subsequent components via the Internet. That is, an HBS might contain appropriate hardware and software that allows the HBS to connect to the Internet via standard wired or wireless connections. Data transmitted from a user device to the HBS via an RF signal might be transmitted from the HBS to the subsequent components in the telecommunications network via the Internet connection. In this way, an owner of an HBS might be able to conduct wireless communications in a location where a traditional base station is inaccessible or where access to a traditional base station is unreliable.

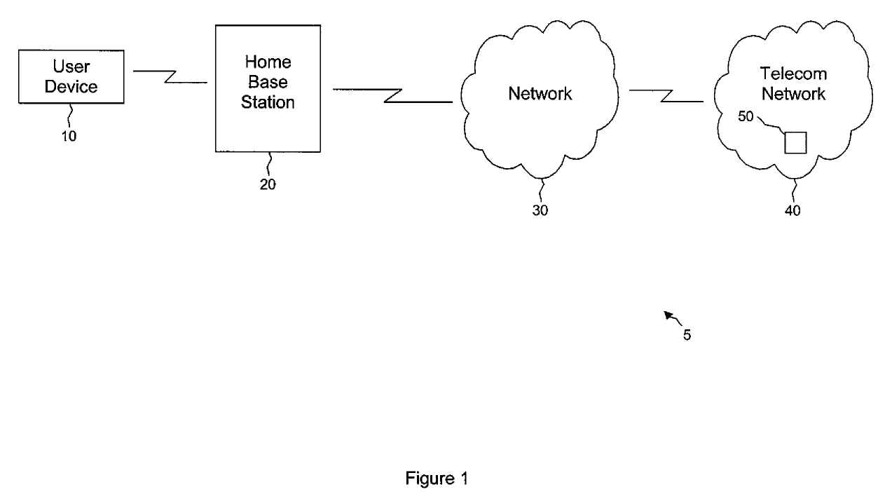

FIG. 1 illustrates an embodiment of a system 5 for communication via a home base station (HBS). A user device 10 can communicate wirelessly with an HBS 20 that is intended to be used only by that user device 10 or by a small set of user devices 10. The HBS 20 can connect to a network 30, such as the Internet, through a wired or wireless connection. Via the network 30, the HBS 20 can connect to a telecommunications network 40, which might be a code division multiple access (COMA) network or some other well known type of telecommunications network. In this way, when the user device 10 is near the HBS 20, the user device 10 can engage in wireless telecommunications when there is no traditional base station nearby or when access to a traditional base station is unreliable.

The telecommunications network 40 might include a component 50 that can perform at least some of the functions related to communication with the HBS 20. Actions that are described herein as happening to the network 40 or as being taken by the network 40 should be understood as possibly happening to or being taken by one or more such components 50 within the network 40, such as servers or other computing devices. The components 50 may be operated, for example, by the telecommunications network provider or wireless network provider associated with the user device 10.

A pseudorandom noise (PN) sequence is typically used to provide a unique identifier for a cell site. That is, a PN can be viewed as a code by which a base station can be identified. A base station typically includes its PN in the beacon signal that it broadcasts and user devices that receive the beacon signal can use the PN to identify the base station. For traditional, publicly accessible base stations, PNs are typically assigned manually by a telecommunications operator or other entity that has control over the base stations. The manual PN assignment process can ensure that each base station in a geographic region has a unique PN and that the identity of a base station is unambiguously provided to user devices that receive the base station's beacon signal.

The unique PNs allow calls to be handed off from one traditional base station to another without ambiguity. A traditional handoff might be initiated when a user device detects a signal that is significantly stronger (typically 3 dB stronger) than the signal it is currently using. The user device then reports the PN of the base station with the stronger signal to the base station with which it is currently in contact. The base station with which the user device is currently in contact then informs a mobile switching center (MSC) that the user device wishes to hand the call off from its current base station to the base station with the reported PN. The MSC then instructs the base station with the reported PN to allocate resources for the call. The base station with the reported PN allocates the resources and informs the MSC that it has done so. The MSC then informs the current base station that the base station with the reported PN is ready for the call and the call is handed off from the current base station to the base station with the reported PN. Since this PN is unique, there is no uncertainty regarding which base station the call should be handed off to.

By contrast, the number of PNs that are dedicated for use by HBSs in a given region might be relatively low. It is possible that the same PN could be assigned to two or more HBSs that are under the control of the same MSC. This redundancy in PN assignment could lead to ambiguity when a call handoff needs to occur. For example, when a user device detects a signal from an HBS that is significantly stronger than the signal from its current base station, the user device might request a handoff to the HBS. If the PN for this HBS is being used by other HBSs under the control of the same MSC, the MSC might instruct one of the other HBSs to allocate resources for the call. Since the HBS that allocates the resources for the call is different from the HBS that the user device intended to hand off to, the call might be dropped.

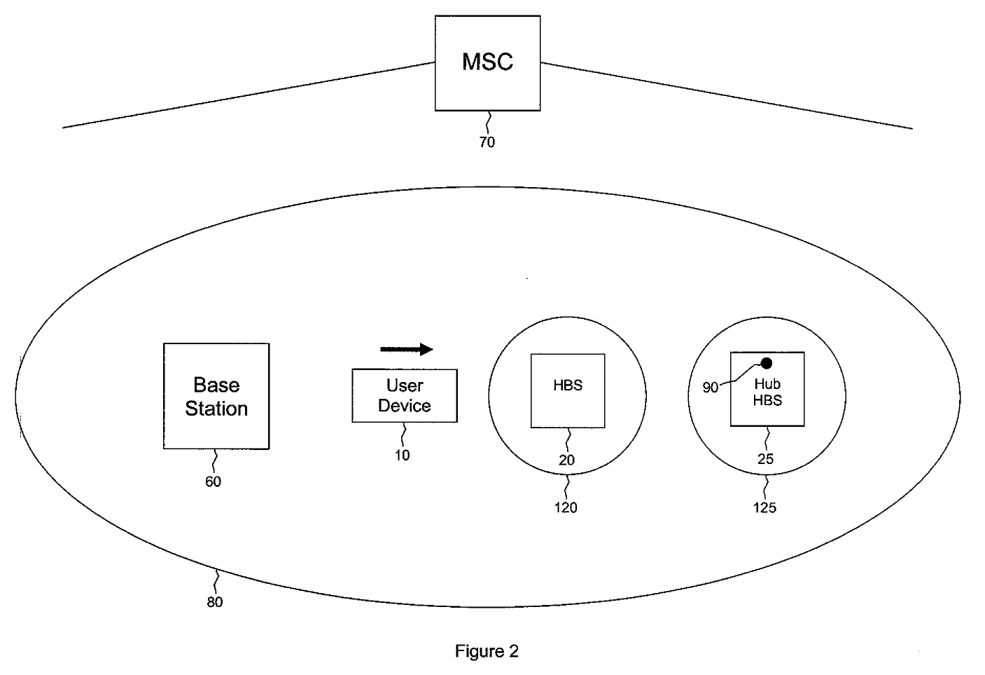

FIG. 2 can illustrate how such a handoff failure might occur. A traditional base station 60, a first HBS 20, and a second HBS 25 are under the control of the same MSC 70. In other embodiments, the traditional base station 60, the first HBS 20, and/or the second HBS 25 might be controlled by more than one MSC. The traditional base station 60 might communicate with the MSC 70 via RF signals in the traditional manner. The first HBS 20 and the second HBS 25 might communicate with the MSC 70 via the Internet, as described above. In other embodiments, a controlling component other than an MSC might be used.

The traditional base station 60 broadcasts a relatively strong signal in a relatively large region 80 in which the first HBS 20 and the second HBS 25 are located. The first HBS 20 broadcasts a relatively weak signal in a first relatively small region 120 and the second HBS 25 broadcasts a relatively weak signal in a second relatively small region 125. Region 120 and region 125 are within region 80 and each might represent the immediate vicinity of a home or business. The first HBS 20 and the second HBS 25 have been assigned the same PN because of the small number of PNs available for HBSs in region 80.

The user device 10 has been associated with the second HBS 25, which can be referred to as the hub HBS 25 for the user device 10. That is, the hub HBS 25 has been configured to communicate with the user device 10, but the first HBS 20 has not been so configured. The user device 10 has a call in progress and is moving away from the traditional base station 60 toward the first HBS 20. As used herein, the term “call” can refer to a voice call or a data call.

As an example, the user of the user device 10 might be driving toward the user's home, where the hub HBS 25 is located. On the way the user might pass by another home where the first HBS 20 is located. The user device 10 might pick up a signal from the first HBS 20 as the user passes by the first HBS 20 and might pick up a signal from the hub HBS 25 as the user approaches the hub HBS 25. The signal might be a beacon signal as is generally used for inter-frequency handoffs or might be a pilot channel as can be used with either inter- or intra-frequency handoffs. As used herein, the term “signal”, when used in these contexts, can refer to either type of signal.

As the user device 10 moves, the signal strength it measures from the traditional base station 60 might decrease and the signal strength it measures from the first HBS 20 might increase. When the signal strength from the first HBS 20 becomes significantly stronger than the signal strength from the traditional base station 60, the user device 10 might inform the traditional base station 60 that it has detected a stronger signal and might request that the call be handed off. The signal from the first HBS 20 includes the PN of the first HBS 20 and the user device 10 includes this PN in its handoff request when it sends the handoff request to the traditional base station 60. The traditional base station 60 then informs the MSC 70 that the call can be handed off to a base station that has the PN reported by the user device 10.

The MSC 70 is aware that there are multiple HBSs in the region 50 that use the same PN. When the MSC 70 receives a handoff request that specifies a PN used by multiple HBSs, the MSC 70 might respond in one of several different ways, depending on how the MSC 70 has been configured. In some cases, the MSC 70 might designate the hub HBS of the user device making the handoff request as the intended recipient of the handoff. In the example of FIG. 1, when the MSC 70 receives a handoff request related to a PN used by multiple HBSs, it can be assumed that the MSC 70 acts in this manner and designates the hub HBS of the user device that made the handoff request to be the intended recipient of the handoff.

The handoff request sent from the traditional base station 60 to the MSC 70 includes an identifier for the user device 10. The MSC 70 might contain a table or similar data structure that relates identifiers for user devices to identifiers for the hub HBSs of those user devices. In the example of FIG. 1, the table would map the identifier for the user device 10 to the identifier for the hub HBS 25. Since the MSC 70 knows that the hub HBS 25 is the hub HBS for the user device 10, the MSC 70 knows to designate the hub HBS 25 as the intended recipient of the handoff. The MSC 70 then informs the hub HBS 25 to prepare to receive the handoff.

The hub HBS 25 then allocates the appropriate resources to receive the handoff and informs the MSC 70 that the resources have been allocated. The MSC 70 then informs the traditional base station 60 that the resources have been allocated and the traditional base station 60 informs the user device 10 that the handoff can proceed. The user device 10 attempts to hand the call off to a base station that has the PN specified in the signal it received from the first HBS 20, but it is unaware that there are two HBSs with that PN. A handoff attempt to the first HBS 20 will fail because the first HBS 20 does not have resources allocated for the call. A handoff attempt to the hub HBS 25 will fail because the hub HBS 25 is out of range of the user device 10. Therefore, the handoff does not occur and the call may be dropped.

Embodiments of the present disclosure can reduce the likelihood of handoff failures in such circumstances. FIG. 2 can be used again to illustrate these embodiments. A call is again assumed to be in progress on the user device 10 and the circumstances leading to the attempted handoff of the call can be assumed to be similar to those described above. In an embodiment, the hub HBS 25 includes a sensing component 90 that can determine when the user device 10 is near the hub HBS 25. The sensing component 90 might be a hardware and/or software-based component that can use the strength of a signal between the user device 10 and the hub HBS 25, the identifier for the user device 10, and other parameters to determine if the user device 10 is sufficiently close to the hub HBS 25 to reliably communicate with the hub HBS 25. When the user device 10 is near enough to the hub HBS 25 to promote successful communication between the user device 10 and the hub HBS 25, the user device 10 can be said to be within range of the hub HBS 25.

In an embodiment, the sensing component 90 might measure the strengths of the reverse channel signals that the hub HBS 25 is receiving from user devices. The hub HBS 25 might be aware of the identifiers for any user devices with which it is associated. A device identifier might be a private long code mask (PLCM), a mobile equipment identifier (MEID), or some other identifier well known to one of skill in the art. The sensing component 90 might use the reverse channel signal strength and the user device identifier to determine if a user device with which the hub HBS 25 is associated is in a region, such as region 125, near the hub HBS 25. In other embodiments, the sensing component 90 might use other techniques to determine if a user device with which the hub HBS 25 is associated is in range of the hub HBS 25.

In an embodiment, after the hub HBS 25 is informed by the MSC 70 of a handoff request and the hub HBS 25 allocates resources for the handoff, the sensing component 90 senses if the user device 10 is nearby. If the sensing component 90 determines that the user device 10 is in range of the hub HBS 25, the handoff proceeds and the call is passed from the traditional base station 60 to the hub HBS 25. If the sensing component 90 determines that the user device 10 is not in range of the hub HBS 25, the hub HBS 25 informs the MSC 70 to not allow the handoff and the user device 10 remains connected to the traditional base station 60.

In this way, dropped calls can be prevented when multiple HBSs under the control of the same MSC use the same PN. For example, as the user device 10 approaches the first HBS 20, the user device 10 might detect the PN of the first HBS 20. As described above, the user device 10 might then request a handoff to a base station with that PN and the hub HBS 25 might be directed to allocate resources to receive the handoff. The sensing component 90 in the hub HBS 25 would sense that the user device 10 is not in range of the hub HBS 25 and therefore the handoff would not be allowed.

If the user device 10 continued to move toward the hub HBS 25, the user device 10 might come into range of the hub HBS 25 and might detect the PN of the hub HBS 25. The user device 10 might again request a handoff to a base station with that PN and the hub HBS 25 might again be directed to allocate resources to receive the handoff. In this case, the sensing component 90 would sense that the user device 10 is in range of the hub HBS 25 and the handoff to the hub HBS 25 would proceed.

In another embodiment, the determination of whether the user device 10 is sufficiently near the hub HBS 25 might be made by a plurality of readings from a global positioning system (GPS) or a similar position determination system, rather than by the sensing component 90. The user device 10, the hub HBS 25, and the traditional base station 60 might all be GPS-enabled. The hub HBS 25 might send its GPS-determined location to the MSC 70 upon powering up. The user device 10 might report its location to the MSC 70 upon attempting a handoff. The MSC 70 might use these two locations to determine if the user device 10 is sufficiently close to the hub HBS 25. If the user device 10 is in range of the hub HBS 25, the MSC 70 might allow the handoff to proceed. If the user device 10 is not in range of the hub HBS 25, the MSC 70 might prevent the handoff from proceeding. Alternatively, the MSC 70 might use the GPS-determined location of the traditional base station 60 to narrow the list of HBSs to which the user device 10 can hand off a call.

One of skill in the art will recognize that as long as a user device receives a signal that is significantly stronger than the signal that it is currently using, the user device will continue to attempt to hand off to the base station that has the stronger signal. For example, if the user device 10 were to remain in region 120, the user device 10 might repeatedly attempt to hand off to the first base station 20. The sensing component 90 would then repeatedly determine that the user device 10 is not in range of the hub HBS 25 and would repeatedly prevent the handoff from occurring.

In an embodiment, a timer might be used to prevent such repetitive retries of a handoff. When the sensing component 90 first prevents a handoff, the timer might be started and the user device 10 might be prevented from attempting further handoffs using the same PN until a predefined period of time has elapsed on the timer.

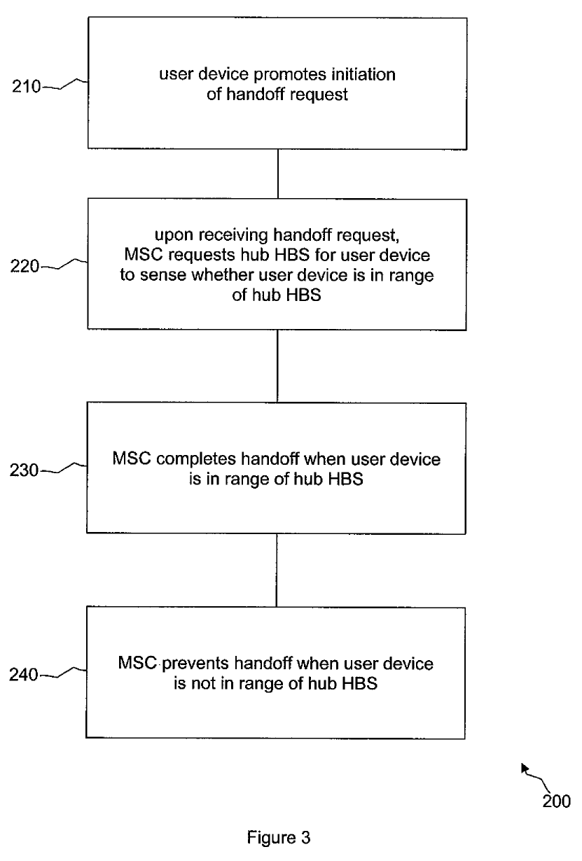

FIG. 3 illustrates an embodiment of a method 200 for reducing the likelihood of a failure of a handoff to an HBS. In block 210, a user device promotes the initiation of a handoff request. In block 220, upon receiving the handoff request, an MSC requests the hub HBS for the user device to sense whether the user device is in range of the hub HBS. In block 230, the MSC completes the handoff when the user device is in range of the hub HBS. In block 240, the MSC prevents the handoff when the user device is not in range of the hub HBS.

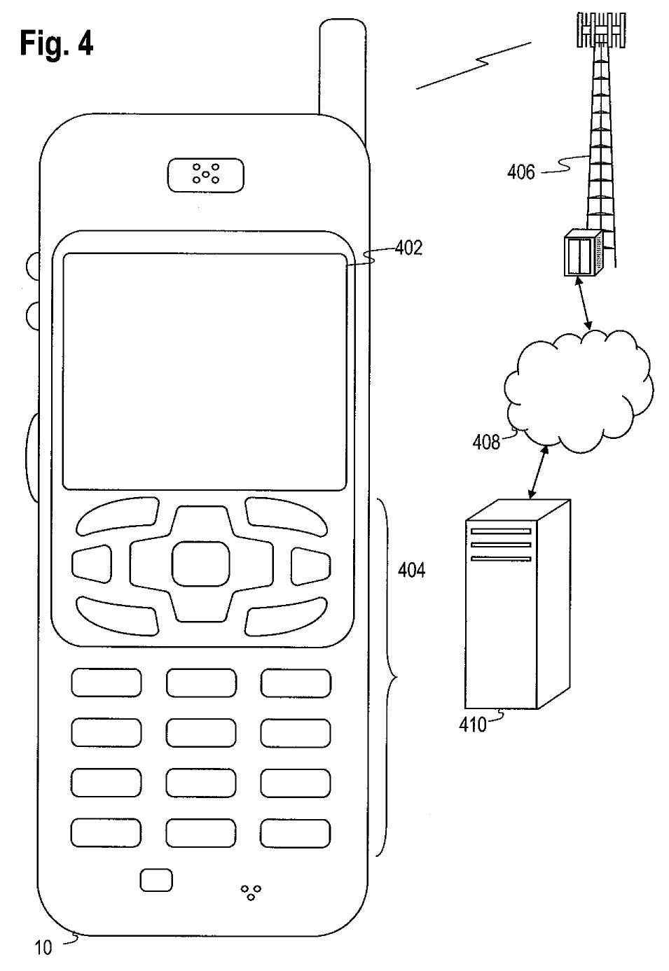

FIG. 4 shows a wireless communications system including an embodiment of the user device 10. The user device 10 may be operable for implementing aspects of the present disclosure, but the present disclosure should not be limited to these implementations. Though illustrated as a mobile phone, the user device 10 may take various forms including a wireless handset, a pager, a personal digital assistant (PDA), a portable computer, a tablet computer, or a laptop computer. Many suitable handsets combine some or all of these functions. In some embodiments of the present disclosure, the user device 10 is not a general purpose computing device like a portable, laptop or tablet computer, but rather is a special-purpose communications device such as a mobile phone, wireless handset, pager, or PDA. The user device 10 may support specialized activities such as gaming, inventory control, job control, and/or task management functions, and so on.

The user device 10 includes a display 402 and a touch-sensitive surface or keys 404 for input by a user. The user device 10 may present options for the user to select, controls for the user to actuate, and/or cursors or other indicators for the user to direct. The user device 10 may further accept data entry from the user, including numbers to dial or various parameter values for configuring the operation of the handset. The user device 10 may further execute one or more software or firmware applications in response to user commands. These applications may configure the user device 10 to perform various customized functions in response to user interaction. Additionally, the user device 10 may be programmed and/or configured over-the-air, for example from a wireless base station, a wireless access point, or a peer user device 10.

The user device 10 may execute a web browser application which enables the display 402 to show a web page. The web page may be obtained via wireless communications with a cell tower 406, a wireless network access node, a peer user device 10 or any other wireless communication network or system, such as the telecommunications network 40 of FIG. 1. The cell tower 406 (or wireless network access node) is coupled to a wired network 408, such as the Internet. Via the wireless link and the wired network, the user device 10 has access to information on various servers, such as a server 410. The server 410 may provide content that may be shown on the display 402. Alternately, the user device 10 may access the cell tower 406 through a peer user device 10 acting as an intermediary, in a relay type or hop type of connection.

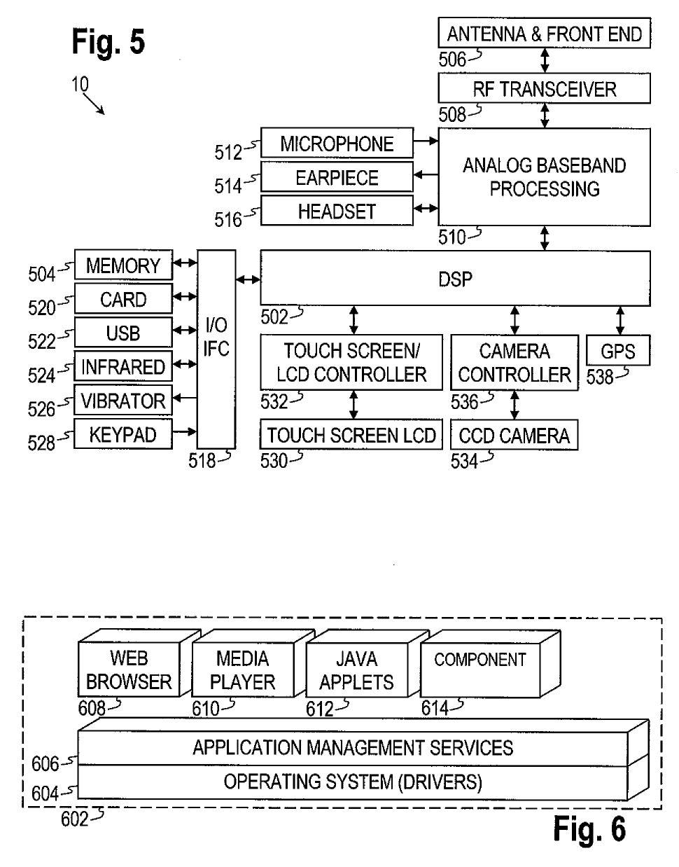

FIG. 5 shows a block diagram of the user device 10. While a variety of known components of user devices 10 are depicted, in an embodiment a subset of the listed components and/or additional components not listed may be included in the user device 10. The user device 10 includes a digital signal processor (DSP) 502 and a memory 504. As shown, the user device 10 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538. In an embodiment, the user device 10 may include another kind of display that does not provide a touch sensitive screen. In an embodiment, the DSP 502 may communicate directly with the memory 504 without passing through the input/output interface 518.

The DSP 502 or some other form of controller or central processing unit operates to control the various components of the user device 10 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the user device 10 to send and receive information from a cellular network or some other available wireless communications network or from a peer user device 10. In an embodiment, the antenna and front end unit 506 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 506 may include antenna tuning and/or impedance matching components, RF power amplifiers, and/or low noise amplifiers.

The RF transceiver 508 provides frequency shifting, converting received RF signals to baseband and converting baseband transmit signals to RF. In some descriptions a radio transceiver or RF transceiver may be understood to include other signal processing functionality such as modulation/demodulation, coding/decoding, intedeaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 510 and/or the DSP 502 or other central processing unit. In some embodiments, the RF Transceiver 508, portions of the Antenna and Front End 506, and the analog baseband processing unit 510 may be combined in one or more processing units and/or application specific integrated circuits (ASICs).

The analog baseband processing unit 510 may provide various analog processing of inputs and outputs, for example analog processing of inputs from the microphone 512 and the headset 516 and outputs to the earpiece 514 and the headset 516. To that end, the analog baseband processing unit 510 may have ports for connecting to the built-in microphone 512 and the earpiece speaker 514 that enable the user device 10 to be used as a cell phone. The analog baseband processing unit 510 may further include a port for connecting to a headset or other hands-free microphone and speaker configuration. The analog baseband processing unit 510 may provide digital-to-analog conversion in one signal direction and analog-to-digital conversion in the opposing signal direction. In some embodiments, at least some of the functionality of the analog baseband processing unit 510 may be provided by digital processing components, for example by the DSP 502 or by other central processing units.

The DSP 502 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 502 may perform modulation, coding, interleaving, and spreading, and for a receiver function the DSP 502 may perform despreading, deinterleaving, decoding, and demodulation. In another embodiment, for example in an orthogonal frequency division multiplex access (OFDMA) technology application, for the transmitter function the DSP 502 may perform modulation, coding, interleaving, inverse fast Fourier transforming, and cyclic prefix appending, and for a receiver function the DSP 502 may perform cyclic prefix removal, fast Fourier transforming, deinterleaving, decoding, and demodulation. In other wireless technology applications, yet other signal processing functions and combinations of signal processing functions may be performed by the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the user device 10 to function as a peripheral device to exchange information with a personal computer or other computer system. The infrared port 524 and other optional ports such as a Bluetooth interface or an IEEE 802.11 compliant wireless interface may enable the user device 10 to communicate wirelessly with other nearby handsets and/or wireless base stations.

The input/output interface 518 may further connect the DSP 502 to the vibrator 526 that, when triggered, causes the user device 10 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the user device 10. Another input mechanism may be the touch screen LCD 530, which may also display text and/or graphics to the user. The touch screen LCD controller 532 couples the DSP 502 to the touch screen LCD 530.

The CCD camera 534 enables the user device 10 to take digital pictures. The DSP 502 communicates with the CCD camera 534 via the camera controller 536. In another embodiment, a camera operating according to a technology other than Charge Coupled Device cameras may be employed. The GPS sensor 538 is coupled to the DSP 502 to decode global positioning system signals, thereby enabling the user device 10 to determine its position. Various other peripherals may also be included to provide additional functions, e.g., radio and television reception.

FIG. 6 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the user device 10. Also shown in FIG. 6 are a web browser application 608, a media player application 610, and Java applets 612. The web browser application 608 configures the user device 10 to operate as a web browser, allowing a user to enter information into forms and select links to retrieve and view web pages. The media player application 610 configures the user device 10 to retrieve and play audio or audiovisual media. The Java applets 612 configure the user device 10 to provide games, utilities, and other functionality. A component 614 might provide functionality related to the HBS 25.

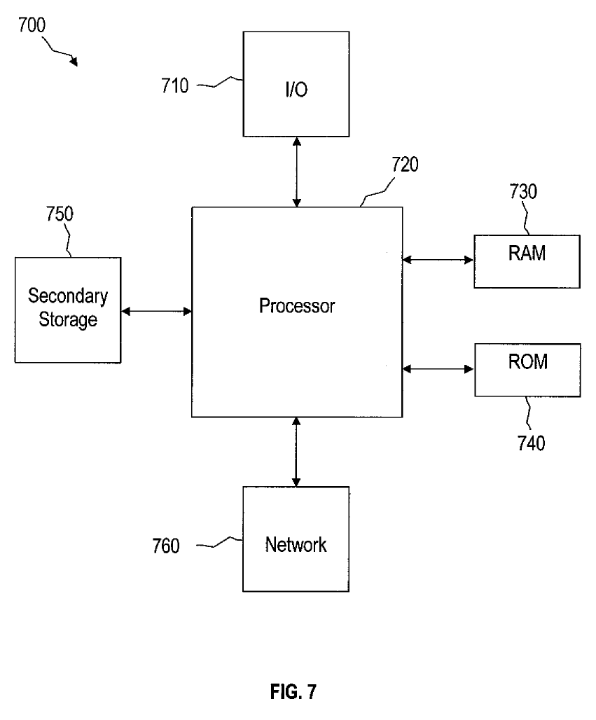

The HBS 25 may include any general-purpose or special-purpose computer with sufficient processing power, memory resources, and network throughput capability to handle the necessary workload placed upon it. FIG. 7 illustrates a typical, general-purpose computer system 700 that may be suitable for implementing one or more embodiments disclosed herein. Similar components and functions might also be applicable to a suitable special-purpose computer. The computer system 700 includes a processor 720 (which may be referred to as a central processor unit or CPU) that is in communication with memory devices including secondary storage 750, read only memory (ROM) 740, random access memory (RAM) 730, input/output (I/O) devices 710, and network connectivity devices 760. The processor may be implemented as one or more CPU chips.

The secondary storage 750 is typically comprised of one or more disk drives or tape drives and is used for non-volatile storage of data and as an over-flow data storage device if RAM 730 is not large enough to hold all working data. Secondary storage 750 may be used to store programs which are loaded into RAM 730 when such programs are selected for execution. The ROM 740 is used to store instructions and perhaps data which are read during program execution. ROM 740 is a non-volatile memory device which typically has a small memory capacity relative to the larger memory capacity of secondary storage. The RAM 730 is used to store volatile data and perhaps to store instructions. Access to both ROM 740 and RAM 730 is typically faster than to secondary storage 750.

I/O devices 710 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 760 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 760 devices may enable the processor 720 to communicate with an Internet or one or more intranets. With such a network connection, it is contemplated that the processor 720 might receive information from the network, or might output information to the network in the course of performing the above-described method steps. Such information, which is often represented as a sequence of instructions to be executed using processor 720, may be received from and outputted to the network, for example, in the form of a computer data signal embodied in a carrier wave.

Such information, which may include data or instructions to be executed using processor 720 for example, may be received from and outputted to the network, for example, in the form of a computer data baseband signal or signal embodied in a carrier wave. The baseband signal or signal embodied in the carrier wave generated by the network connectivity 760 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 720 executes instructions, codes, computer programs, scripts which it accesses from hard disk, floppy disk, optical disk (these various disk based systems may all be considered secondary storage 750), ROM 740, RAM 730, or the network connectivity devices 760.

While several embodiments have been provided in the present disclosure, it should be understood that the disclosed systems and methods may be embodied in many other specific forms without departing from the spirit or scope of the present disclosure.

The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for reducing a failure of a handoff to a home base station (HBS), comprising:
a user device promoting initiating a handoff request;
responsive to receiving the handoff request from the user device, a mobile switching center (MSC) requesting a hub HBS for the user device to sense whether the user device is in range to communicate with the hub HBS; and
the MSC completing the handoff when the hub HBS senses that the user device is in range and preventing the handoff when the hub HBS does not sense that the user device is in range.

2. The method of claim 1, wherein a sensing component on the hub HBS determines whether the user device is in range to communicate with the hub HBS.

3. The method of claim 2, wherein the sensing component determines whether the user device is sufficiently near the hub HBS to reliably communicate with the hub HBS by measuring a strength of a reverse channel signal from the user device.

4. The method of claim 1, further comprising the MSC determining that the user device is associated with the hub HBS by associating an identifier for the user device with an identifier for the hub HBS.

5. The method of claim 4, wherein the identifier for the user device is one of a private long code mask and a mobile equipment identifier.

6. The method of claim 1, further comprising, when a first attempt to perform the handoff is prevented, preventing a second attempt to perform the handoff until a predefined length of time has passed since the first attempt.

7. The method of claim 1, wherein the handoff is attempted in a code division multiple access telecommunications system.

8. A system for reducing a failure of a handoff to a home base station (HBS), comprising:
a mobile switching center (MSC) operable to identify a hub HBS for a user device as an intended recipient of a call handoff when the MSC receives a handoff request related to a pseudorandom noise sequence (PN) that is used by a plurality of HBSs controlled by the MSC; and
a sensing component on the hub HBS to determine whether the user device is near enough to the hub HBS to communicate with the hub HBS, and further operable, when the user device is near enough to the hub HBS to communicate with the hub HBS, to promote the hub HBS receiving the call handoff, and, when the user device is not near enough to the hub HBS to communicate with the hub HBS, to cause the MSC to prevent the call handoff.

9. The system of claim 8, wherein the sensing component determines whether the user device is near enough to the hub HBS to reliably communicate with the hub HBS by measuring a strength of a reverse channel signal from the user device.

10. The system of claim 8, wherein the MSC determines that the user device is associated with the hub HBS by associating an identifier for the user device with an identifier for the hub HBS.

11. The system of claim 10, wherein the identifier for the user device is one of a private long code mask and a mobile equipment identifier.

12. The system of claim 8, further comprising a timer operable, when a first attempt to perform the handoff is prevented, to prevent a second attempt to perform the handoff until a predefined length of time has passed since the first attempt.

13. The system of claim 8, wherein the handoff is attempted in a code division multiple access telecommunications system.

14. A home base station (HBS), comprising:
a sensing component operable to determine whether a user device registered with the HBS is near enough to the HBS to sufficiently communicate with the HBS, and further operable, when the user device is near enough to the HBS to sufficiently communicate with the HBS, to allow the HBS to receive a handoff of a call, and, when the user device is not near enough to the HBS to sufficiently communicate with the HBS, to cause a mobile switching center (MSC) to prevent the handoff.

15. The HBS of claim 14, wherein the sensing component determines whether the user device is near enough to the HBS to sufficiently communicate with the HBS upon the HBS being designated by the MSC as an intended recipient of the handoff.

16. The HBS of claim 15, wherein the MSC designates the HBS as the intended recipient of the handoff upon the MSC receiving a handoff request related to a pseudorandom noise sequence (PN) used by the HBS and by at least one other HBS controlled by the MSC.

17. The HBS of claim 14, wherein the MSC determines that the user device is associated with the hub HBS by associating an identifier for the user device with an identifier for the hub HBS.

18. The HBS of claim 17, wherein the identifier for the user device is one of a private long code mask and a mobile equipment identifier.

19. The HBS of claim 14, further comprising a timer operable, when a first attempt to perform the handoff is prevented, to prevent a second attempt to perform the handoff until a predefined length of time has passed since the first attempt.

20. The HBS of claim 14, wherein the handoff is attempted in a code division multiple access telecommunications system.
